(19) United States
(12) Patent Application Publication
(10) Pub. No.: US 2002/0122703 A1
(43) Pub. Date: Sep. 5, 2002

(54) Quick change adaptor for hole saw

(76) Inventors: Peter Czyzewski, Rockford, IL (US); Thomas J. Pearson, Rockford, IL (US); Jeffrey J. Plummer, Rockford, IL (US); Thomas G. Boese, Rockford, IL (US)

Correspondence Address: Trexler, Bushnell, Giangiorgi, Blackstone & Marr, Linda L. Palomar,, 105 West Adams Street, Floor 36, Chicago, IL, 60603, US

(21) Appl. No.: 10/068,421

(22) Filed: Feb. 6, 2002

Related U.S. Application Data
(60) Provisional application No. 60/269,466, filed on Feb. 16, 2001.

(51) Int. Cl. B23B 51/04

(52) U.S. Cl. 408/1 R; 408/204

(57) ABSTRACT

A quick change adaptor for a hole saw includes an arbor, a collar and a retaining nut. The adaptor allows a hole saw to be easily and efficiently mounted and dismounted to and from the adaptor. When mounted to the adaptor, the hole saw and collar rotate relative to the arbor and the retaining nut. Rotation of the collar and hole saw relative to the retaining nut is limited by the interaction between an arbor boss and a collar recess to provide a drive force to the hole saw.

### RELATED APPLICATIONS

This application claims the priority of U.S. provisional application Serial No. 60/269,466 filed on Feb. 16, 2001 and entitled “Quick Change Adaptor For Hole Saw”.

### BACKGROUND OF THE INVENTION

This invention relates to a quick-change adaptor which is used to attach a hole saw to an electric drill. Hole saws are commonly used in connection with electric drills to create holes in work pieces. It is often necessary to create holes of varying sizes and therefore is convenient to be able to quickly mount and dismount hole saws of different sizes to and from an electric drill.

A quick-change mandrel has previously been described in U.S. Pat. No. 4,303,357 ('357 patent). The mandrel of the '357 patent uses a locking segment in connection with an aperture in the back plate of the hole saw to secure the hole saw to the mandrel. To mount the hole saw on the mandrel, the locking segment is passed through the aperture, the hole saw is rotated relative to the mandrel, and the back plate of the hole saw is positioned behind the shoulders of the locking segment. Because the hole saw must rotate relative to the locking segment, the shape of the aperture in the back plate of the hole saw is not the same as the shape of the locking segment behind the shoulders. The difference between the shape of the locking segment and the shape of the aperture results in a reduced area of contact between the locking segment and the hole saw and therefore a reduced drive surface.

Another disadvantage of the mandrel described in the '357 patent is that the reaction force of the work piece against the hole saw is needed to hold the hole saw behind the shoulders of the locking segment. When the hole saw is not in use, there is no reaction force holding the hole saw on the adaptor which could allow the adaptor to inadvertently rotate. If the rotation is significant, the hole saw may inadvertently dismount from the mandrel.

In addition, when the hole saw of the '357 patent is in use, there is often play between the end wall or back plate of the hole saw and the mandrel causing inadvertent rotation of the hole saw relative to the mandrel and movement of the hole saw axially.

### OBJECTS AND SUMMARY OF THE INVENTION

A general object of the present invention is to provide an adaptor which allows for easy mounting of a hole saw to an electric drill and dismounting of the hole saw from an electric drill.

Another object of the present invention is to maximize the area of the drive surface between the adaptor and the hole saw.

Yet, another object of the present invention is to provide an adaptor which prevents inadvertent rotation of the hole saw relative to the adaptor.

Still, another object of the present invention is to provide an adaptor which provides tensioning between the adaptor and the hole saw to eliminate free play between the adaptor and the hole saw.

Briefly, and in accordance with the foregoing, an adaptor includes a collar which is capable of rotation relative to an arbor and locking nut. An arbor boss is placed within a corresponding collar recess to provide a driving force to the collar which in turn drives the hole saw. Several configurations of the arbor boss and corresponding collar recess are provided. The collar includes a collar boss which is shaped in the same manner as the aperture in the back plate of the hole saw. The hole saw can be quickly mounted on the adaptor by passing the locking nut through the aperture in the back plate, placing the collar boss within the aperture and rotating the hole saw and collar relative to the locking nut and arbor. Tensioning elements are provided to eliminate inadvertent rotation or axial movement of the hole saw.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of an assembled adaptor shown partially in cross-section which incorporates the features of a first embodiment of the invention and a hole saw for use with the adaptor also shown partially in cross-section;

FIG. 2 is an exploded perspective view of the adaptor and hole saw of FIG. 1 shown partially in cross-section from a distal vantage point;

FIG. 3 is an exploded perspective view of the adaptor and hole saw of FIGS. 1 and 2 shown partially in cross-section from a proximal vantage point;

FIG. 4 is a perspective view of the assembled adaptor shown partially in cross section which incorporates the features of a second embodiment of the invention and a hole saw for use with the adaptor also shown partially in cross section;

FIG. 5 is an exploded perspective view of the adaptor and hole saw of FIG. 4 shown partially in cross section from a distal vantage point;

FIG. 6 is an exploded perspective view of the adaptor and hole saw of FIGS. 4 and 5 from a proximal vantage point;

FIG. 7 is a perspective view of the assembled adaptor shown partially in cross-section which incorporates the features of a third embodiment of the invention and a hole saw for use with the adaptor also shown partially in cross section;

FIG. 8 is an exploded perspective view of the adaptor and hole saw shown in FIG. 7 shown partially in cross-section from a distal vantage point;

FIG. 9 is a perspective view of the assembled adaptor shown partially in cross section which incorporates the features of a fourth embodiment of the invention and a hole saw for use with the adaptor also shown partially in cross section;

FIG. 10 is an exploded perspective view of the adaptor and hole saw of FIG. 9 shown partially in cross-section from a distal vantage point;

FIG. 11 is an exploded perspective view of the adaptor which incorporates the features of a fifth embodiment of the invention from a distal vantage point and a hole saw for use with the adaptor also shown partially in cross section;

FIG. 12 is an exploded perspective view of collar of the adaptor of FIG. 11 from a proximal vantage point; and

FIG. 13 is a perspective view of an assembled adaptor with an alternative embodiment of a retaining nut.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein. In describing the invention, use of the word “proximal” shall refer to elements, surfaces or positions closest to a user of the present invention and “distal” shall refer to elements, surfaces or positions furthest from a user of the present invention.

An adaptor which has been designed for easy and inexpensive manufacture is provided. The adaptor allows for the quick assembly and disassembly of a hole saw to and from the adaptor. The quick assembly and disassembly allows for easy use of varying sized hole saws and also allows for the slug which has been cut by the hole saw to be easily ejected from the hole saw.

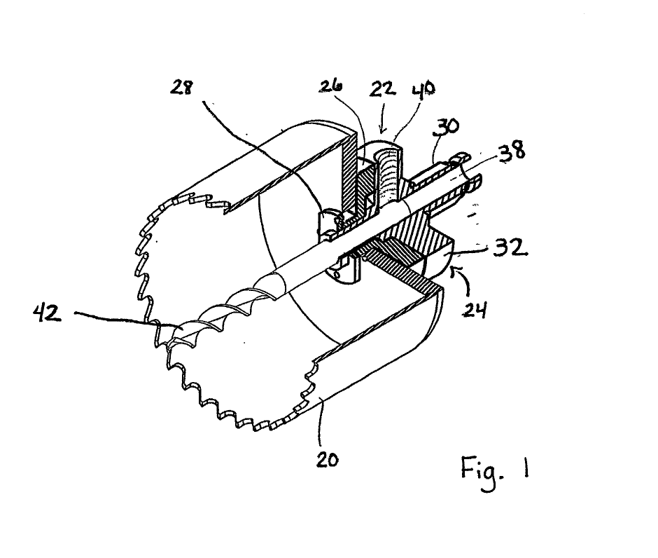

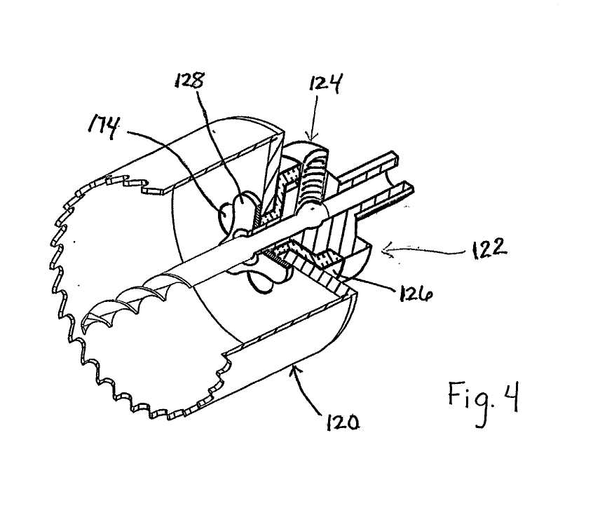

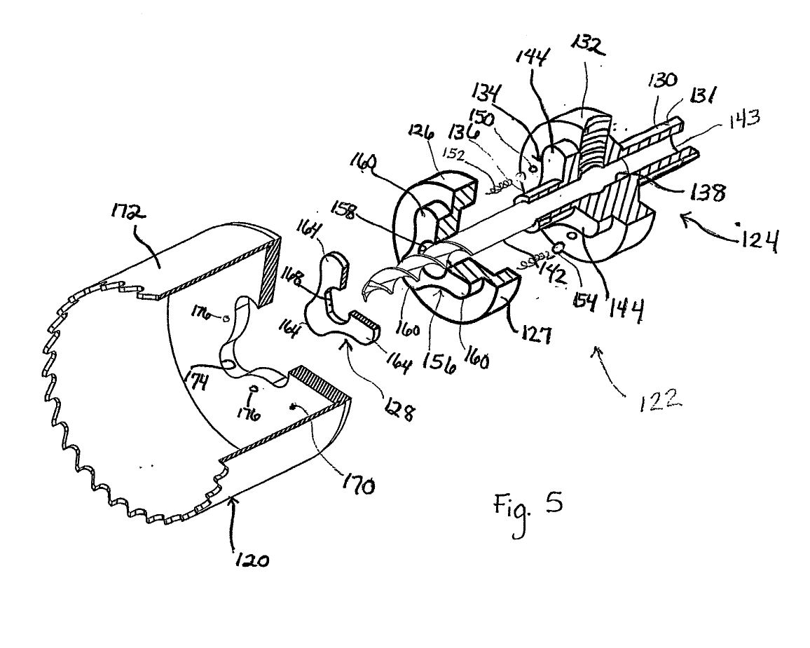

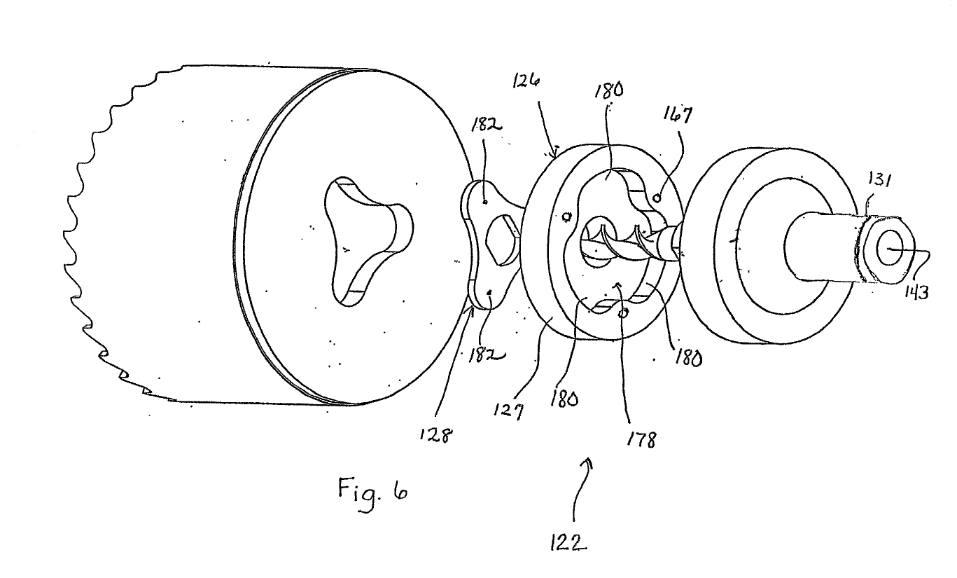

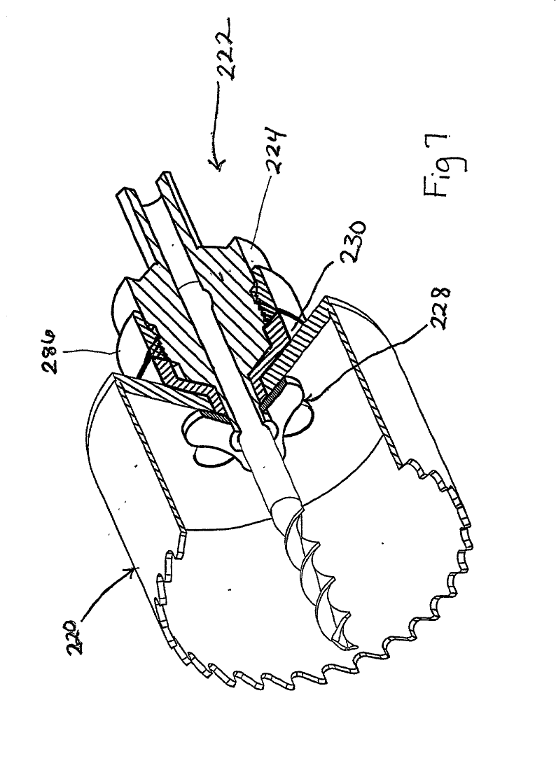

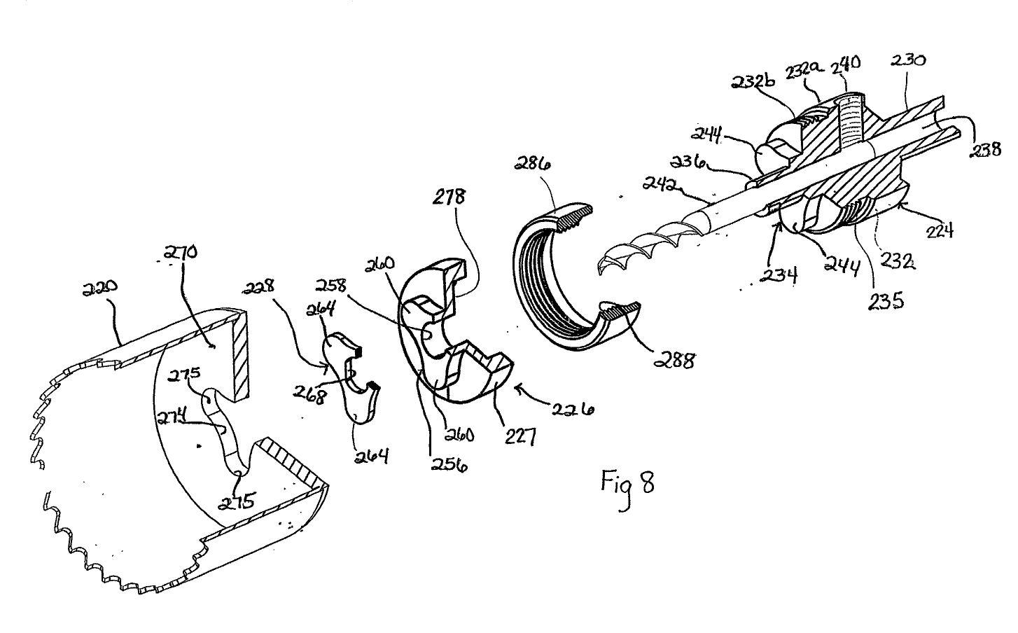

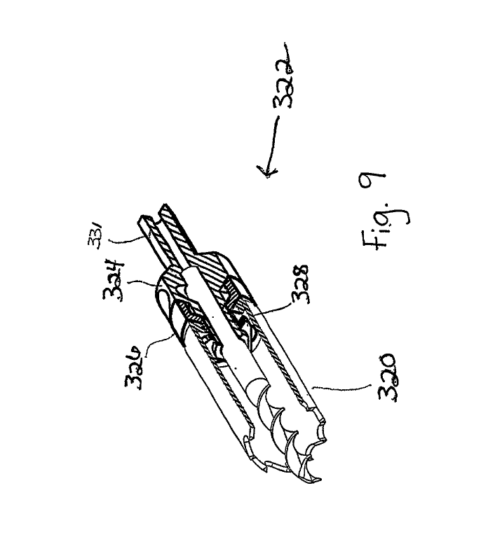

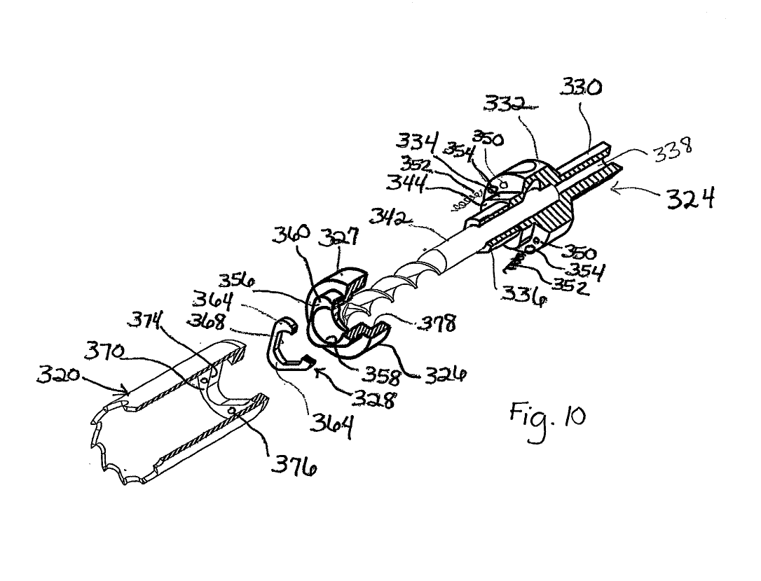

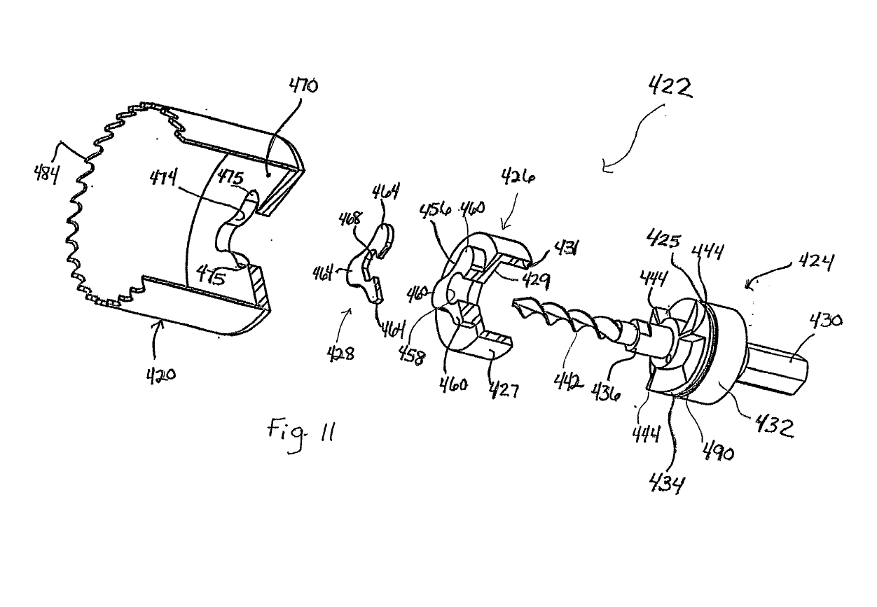

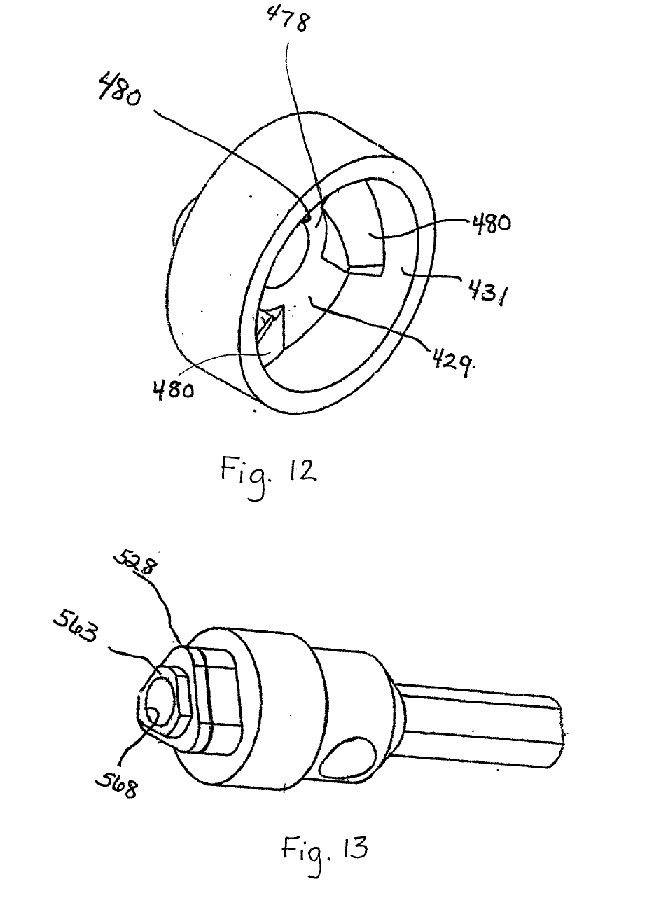

An adaptor 22 is provided which has a hole saw 20 mounted thereon assembled thereto. The adaptor 22 includes a quick change feature which allows the user to mount and dismount a hole saw to and from the adaptor easily and efficiently. Additional tools are not required to mount or dismount the hole saw to and from the adaptor and different sized hole saws can be mounted or dismounted to and from the adaptor with little interruption to the user. A first embodiment of the adaptor 22 is shown in FIGS. 1, 2, and 3, a second embodiment of the adaptor is shown in FIGS. 4, 5, and 6, a third embodiment of the adaptor is shown in FIGS. 7 and 8, a fourth embodiment of the adaptor is shown in FIGS. 9, and 10, and finally a fifth embodiment of the adaptor is shown in FIGS. 11 and 12. An alternative embodiment of a retaining nut is shown in FIG. 13.

Attention is invited to the first embodiment of the adaptor shown in FIG. 1. A hole saw 20 is mounted toward the distal end of the adaptor 22. The hole saw 20 is operated through attachment of conventional driving means, such as, for example, an electric drill (not shown) to the proximal end of the adaptor 22.

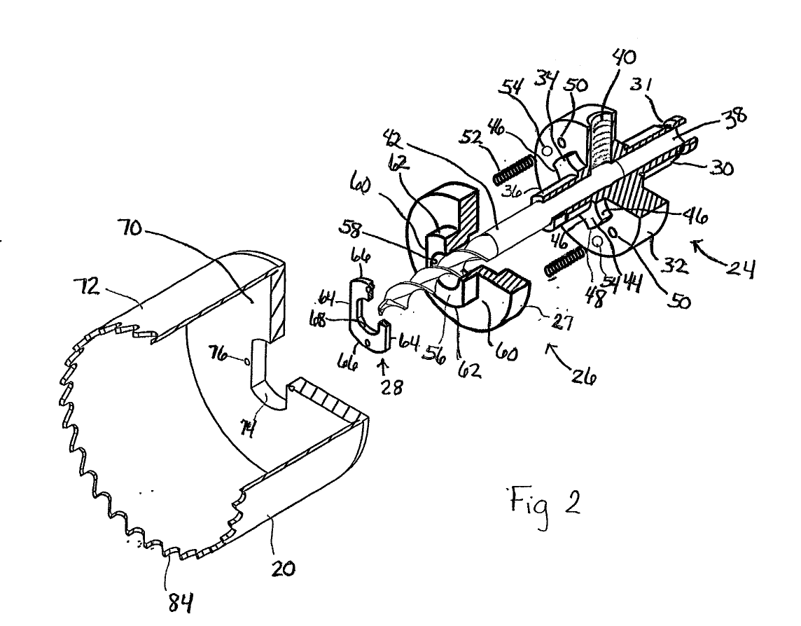

An exploded view of the adaptor 22 from a distal vantage point is shown in FIG. 2. The adaptor 22 includes an arbor 24, a collar 26 and a retaining nut 28.

The arbor 24, which is preferably formed of metal, includes a proximal sleeve 30, an arbor platform 32, an arbor boss 34 and a distal sleeve 36. The proximal sleeve 30, the arbor platform 32, the arbor boss 34 and the distal sleeve 36 are integrally formed. An arbor passageway 38 extends axially through the center of the proximal sleeve 30, the arbor platform 32, the arbor boss 34 and the distal sleeve 36.

The arbor platform 32 is generally cylindrically shaped and is distal of the proximal sleeve 30. The proximal sleeve 30 is generally cylindrically shaped with a diameter smaller than that of the arbor platform 32. A groove 31 is provided near the proximal end of the proximal sleeve 30 for coupling drive means (not shown) to the proximal sleeve 30. A threaded bore 40 extends from the perimeter of the platform 32 to the arbor passageway 38. The threaded bore 40 is perpendicular to the arbor passageway 38.

The arbor boss 34 protrudes from the distal surface of the arbor platform 32. In this first embodiment, the arbor boss 34 has two diametrically opposed lobes 44. Each lobe 44 of the arbor boss 34 has two inwardly curved sides 46 and an outwardly curved end 48.

The length of the arbor boss 34 from one outwardly curved end 48 to the opposite outwardly curved end is smaller than the diameter of the arbor platform 32.

The distal sleeve 36 is elongated and is shaped in the “Double D” configuration with two flat sides and two rounded sides. The distal sleeve extends from the distal surface of the arbor boss 34. The diameter of the distal sleeve 36 is smaller than the diameter of the arbor platform 32.

Recesses 50 are provided in the distal surface of the platform 32 and receive steel balls 54. The diametrically opposed recesses 50 are spaced radially outwardly from the respective curved ends 48 of the arbor boss 34. The steel balls 54 are placed within the recesses 50 and springs 52 rest on the balls 54. As will be described herein, the springs 52 will be compressed and the steel balls 54 will roll on the distal surface of the arbor platform 32 when the hole saw 20 is disassembled from the adaptor 22.

The collar 26 which is preferably formed of metal, includes a collar platform 27 and a collar boss 56 which are integrally formed. A collar passageway 58 extends axially through the center of the collar platform 27 and the collar boss 56. The diameter of the collar passageway 58 is slightly larger than the diameter of distal sleeve 36 of the arbor 24 thus allowing the distal sleeve 36 to pass through the collar passageway 58.

The collar boss 56 protrudes from the distal surface of the collar platform 27. The collar boss 56 has two straight parallel sides 60 and two curved opposite ends 62 such that a “Double D” configuration is formed. The length of the collar boss 56 from one curved end 62 to the opposite curved end 62 and the width of the collar boss 56 from one parallel side 60 to the opposite parallel side 60 are smaller than the diameter of the collar platform 27.

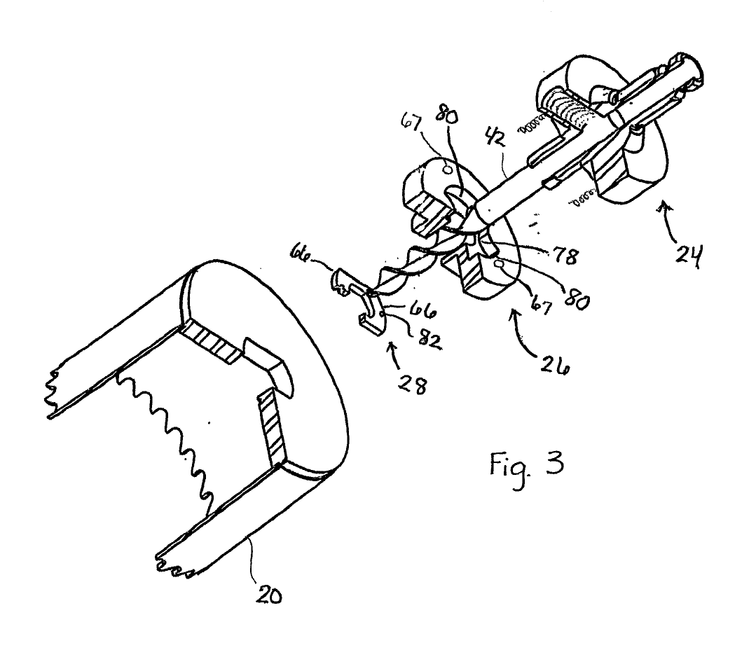

As shown in FIG. 3, a collar recess 78 extends into the proximal surface of the collar platform 27. The collar recess 78 has two diametrically opposed lobes 80 which receive the lobes 44 of the arbor boss 34. The length of the recess from one lobe 80 to the opposite lobe 80 is smaller than the diameter of the collar platform 27. The relative dimensions of the arbor boss 34 and the collar recess 78 are such that the arbor boss 34 can be rotated ninety degrees within the collar recess 78.

Bores 67 are located in the proximal surface of the collar platform 27. The bores 67 receive the springs 52. The height of the collar 26 from the proximal surface of the collar platform 27 to the distal surface of the collar boss 56 relative to the length of the distal sleeve 36 is such that when the arbor boss 34 is positioned within the collar recess 78, the distal sleeve 36 extends beyond the distal surface of the collar boss 56.

The retaining nut 28 is also shaped in the “Double D” configuration with two parallel sides 64 and two curved opposite ends 66. The perimeter of the retaining nut 28 is of the same shape and dimensions as the perimeter of the collar boss 56. The retaining nut 28 has an aperture 68 located at its axial center. The aperture 68 is also shaped in the “Double D” configuration. Two locking protrusions 82 (one of which is shown in FIG. 3) are provided on the proximal surface of the retaining nut 28 and are diametrically opposed and spaced from the curved opposite ends 66 of the retaining nut 28.

To assemble the adaptor 22, the springs 52 are placed within the bores 67 and the steel balls 54 are placed within the recesses 50. The collar 26 is passed over the distal sleeve 36 of the arbor 24. The collar 26 is rotated so as to align the lobes 44 of the arbor boss 34 within the collar recess 78. Next, the distal sleeve 36 of the arbor 24 is passed through the aperture 68 of the retaining nut 28. The locking protrusions 82 retaining nut 28 abut the collar boss 56 and the retaining nut 28 is fixed to the distal sleeve 36 using a peening process. Because the retaining nut 28 is fixed to the distal sleeve 36 of the arbor 24, the retaining nut 28 will rotate with the arbor 24. The collar 26 will rotate relative to the arbor 22 and the retaining nut 28.

The cylindrical shank of a pilot bit 42 is inserted in the arbor passageway 38 and locked in place by tightening a set screw (not shown) located in the threaded bore 40. The pilot drill bit 42 when inserted in the arbor passageway 38, extends through the collar passageway 58 and the aperture 68 in the retaining nut 28.

The hole saw 20 includes a circularly shaped back plate 70 and a cylindrically shaped skirt 72 which depends from the back plate 70. The thickness of the back plate 70 is the same dimension as the height of the collar boss 56. An aperture 74 is provided through the axial center of the back plate 70. The aperture 70 is configured in the “Double D” configuration with two straight side and two rounded ends. The aperture 74 is slightly larger than the perimeter of the retaining nut 28 and the collar boss 56 thus allowing the retaining nut 28 and collar boss 56 to pass through the aperture 74. Inwardly protruding locking detents 76 are located proximate to, but spaced from, the straight edges of the aperture 74 on the distal surface of the back plate 70.

The hole saw 20 is mounted on the adaptor 22 by the user by passing the aperture 74 in the hole saw 20 over the pilot drill bit 42, aligning the retaining nut 28 with the aperture 74 in the back plate 70 of the hole saw 20, passing the hole saw 20 over the retaining nut 28 such that the aperture 74 passes over the retaining nut 28, and aligning the collar boss 56 within the aperture 74. The proximal side of the back plate 70 will abut the distal side of the collar 26. Because the thickness of the back plate 70 is the same dimension as the height of the collar boss 56, the distal surface of the collar boss 56 will be flush with the distal surface of the back plate 70. The user then rotates the hole saw 20 and the collar 26 ninety degrees relative to the arbor 24 and the retaining nut 28, and the locking detents 76 on the back plate 70 of the hole saw 20 engage with the locking protrusions 82 on the retaining nut 28 to lock the hole saw 20 in place. As the hole saw 20 and collar 26 are rotated, the steel balls 58 roll on the distal surface of the arbor platform 32. When the locking detents 76 are aligned with the locking protrusions 82, the steel balls 54 will rest in the recesses 50. The springs 52 force the distal surface of the collar 26 against the proximal surface of the back plate 70 of the hole saw 20 to provide a tight fit of the hole saw 20 on the adaptor 22.

When power is supplied, the drive means which are attached to the proximal sleeve 30 by conventional means, rotate the arbor 24. The lobes 44 of the arbor boss 34 engage with the lobes 80 of the collar recess 78 causing the collar 26 to rotate. The collar boss 56 engages with the hole saw aperture 74 causing the hole saw 20 to rotate. As the hole saw 20 rotates the cutting edge 84 rotates and cuts the surface of the work piece (not shown). A slug formed as a result of cutting a hole in the workpiece, can be removed from the hole saw 20 using the drill bit 42.

The hole saw 20 can be dismounted from the adaptor 22 by grasping the skirt 72 with one hand and the arbor 24 with the other hand. The user pulls the hole saw 20 proximally and compress the springs 52 to disengage the locking detents 76 from the locking protrusions 82. The user then rotates the hole saw 20 along with the collar 26 ninety degrees relative to the retaining nut 28 and arbor 24. The arbor boss 34 will also rotate within the collar recess 78 and will prevent the hole saw 20 and collar 26 from being rotated greater than 90 degrees. Upon rotating the hole saw 20 and collar 26 ninety degrees, the retaining nut 28 and the aperture 74 will be in alignment. As the hole saw 20 and collar 26 are rotated, the steel balls 54 will roll out of the recesses 50 and along the distal surface of the arbor platform 32. Finally, the hole saw 20 is pulled distally over the retaining nut 28 and the hole saw is dismounted from the adaptor 22. The slug which has been cut from the work piece can be ejected from the hole saw 20 by using the pilot drill bit 42.

The second embodiment of the hole saw adaptor 122 is shown in FIG. 4. A hole saw 120 is mounted toward the distal end of the adaptor 122. The assembled adaptor 122 operates in a manner similar to that of the first embodiment shown in FIGS. 1, 2 and 3.

An exploded view of the adaptor 122 from a distal vantage point is shown in FIG. 5. The adaptor 122 includes an arbor 124, a collar 126 and a retaining nut 128.

The arbor 124 which is preferably formed of metal, includes a proximal sleeve 130, an arbor platform 132, an arbor boss 134 and a distal sleeve 136. The proximal sleeve 130, the arbor platform 132, the arbor boss 134 and the distal sleeve 136 are integrally formed. An arbor passageway 138 extends axially through the center of the proximal sleeve 130, the arbor platform 132, the arbor boss 134, and the distal sleeve 136.

The arbor platform 132 is generally cylindrically shaped and is distal of the proximal sleeve 130. The proximal sleeve 130 is generally cylindrically shaped with a diameter smaller than that of the arbor platform 132. A groove 131 is provided near the proximal end of the proximal sleeve 130 for coupling drive means (not shown) to the proximal sleeve 130. A threaded bore 140 extends from the perimeter of the platform 132 to the arbor passageway 138. The threaded bore 140 is perpendicular to the arbor passageway 138.

The arbor boss 134 protrudes from the distal surface of the arbor platform 132 of the arbor 124. In this second embodiment, the arbor boss 134 has three lobes 144 equally spaced circumferentially around the arbor passageway 138. Thus, the center of each lobe 144 is spaced one hundred twenty degrees from the remaining two lobes 144. Portions of two of the lobes 144 are shown. This three lobe configuration is commonly referred to as a “daisy” or “tri-lobular” configuration. The radius of the arbor boss 134 at its largest point is smaller than the diameter of the arbor platform 132.

The distal sleeve 136 is elongated and is shaped in the “Double D” configuration with two diametrically opposed flat sides and two diametrically opposed rounded ends. The distal sleeve 136 extends from the distal surface of the arbor boss 134. The radius of the distal sleeve 136 is smaller than the radius of the arbor boss 134.

Three recesses 150 (two of which are shown) are provided in the distal surface of the arbor platform 132 and receive steel balls 154. The recess 150 are spaced between the lobes 144 of the arbor boss 134. The steel balls 154 are placed within the recesses 150 and springs 152 rest on the balls 154. As will be described herein, the springs 152 provide tensioning and the steel balls will roll on the distal surface of the arbor platform 132 when the hole saw is mounted with or dismounted from the adaptor 122.

The collar 126 which is preferably formed of-metal, includes a collar platform 127 and a collar boss 156 which are integrally formed. A collar passageway 158 extends axially through the center of the collar platform 127 and the collar boss 156. The diameter of the collar passageway 158 is slightly larger than the diameter of the distal sleeve 136 of the arbor 124 thus, allowing the distal sleeve 136 to pass through the collar passageway 158.

A collar boss 156 protrudes from the distal surface of the collar platform 127. The collar boss 156 has three lobes 160 equally spaced circumferentially around the collar passageway 158 in the “daisy” or “tri-lobular” configuration.

As shown in FIG. 6, a collar recess 178 extends into the proximal surface of the collar platform 127. The collar recess 178 has three lobes 180 and is also shaped in the “daisy” or “tri-lobular” configuration. The relative dimensions of the arbor boss 134 and the collar recess 178 are such that the arbor boss 134 fits within the collar recess 178 and can be rotated within the collar recess approximately sixty degrees.

Bores 167 are located in the proximal surface of the collar platform 127 between the lobes 180 of the recess 178. The bores 167 receive the springs 152. The height of the collar 126 from the proximal surface of the collar platform 127 to the distal surface of the collar boss 156 relative to the length of the distal sleeve 136 is such that when the arbor boss 134 is positioned within the collar recess 178, the distal sleeve 136 extends beyond the distal surface of the collar boss 156.

The retaining nut 128 also has three lobes 164 arranged in the “daisy” or “tri-lobular” configuration and an aperture 168 located at its axial center. The aperture 168 is shaped in the “double D” configuration with two flat sides and two rounded ends. The aperture 168 is slightly larger than the perimeter of the distal sleeve. The perimeter of the retaining nut 128 is of the same shape and dimensions as the perimeter of the collar boss 156. Three locking protrusions 182 (two of which are shown in FIG. 6) are provided on the proximal surface of the retaining nut 128. The locking protrusions 182 are spaced outwardly from the aperture 168 on each lobe 164.

To assemble the adaptor 122, the collar passageway 158 is passed over the distal sleeve 136 of the arbor 124. The collar 126 is rotated so as to align the lobes 144 of the arbor boss 134 within the lobes 180 of the collar recess 178. Next, the distal sleeve 136 of the arbor 124 is passed through the aperture 168 of the retaining nut 128. The locking protrusions 182 on the retaining nut 128 abut the collar boss 156 and the retaining nut 128 is fixed to the distal sleeve 136 using apeening process. Because the retaining nut 128 is fixed to the distal sleeve 136 of the arbor 124, the retaining nut 128 will rotate with the arbor 124. The collar 126 will rotate relative to the arbor 122 and the retaining nut 128.

The cylindrical shank of a pilot bit 142 is inserted in the arbor passageway 138 and locked in place by tightening a set screw (not shown) located in the threaded bore 140. The pilot drill bit 142 when inserted in the arbor passageway 138, extends through the collar passageway 158 and the aperture 168 in the retaining nut 128. An aperture 143 is provided at the axial center of the proximal sleeve 130 and leads to the arbor passageway 138. The aperture 143 can be used to push the pilot drill bit out of the arbor passageway 138.

The hole saw 120 includes a circularly shaped back plate 170 and a cylindrically shaped skirt 172 which depends from the back plate 170. The thickness of the back plate 70 is the same dimension as the height of the collar boss 156. An aperture 174 is provided through the axial center of the back plate 170. The aperture 174 is also of the “daisy configuration” and the perimeter of the aperture 174 is slightly larger than the perimeter of the collar boss 156 and the retaining nut 128. Three inwardly protruding locking detents 176 (two of which are shown) are located on the distal surface of the back plate 170 and between the lobes of the aperture 174.

The hole saw 120 is mounted to the adaptor 122 by passing the aperture 174 in the back plate 170 of the hole saw 120 over the pilot drill bit 142, aligning the retaining nut 128 with the aperture 174 in the back plate 170 of the hole saw 120, passing the aperture 174 over the retaining nut 128 and aligning the collar boss 156 within the aperture 174. Because the thickness of the back plate 170 is the same dimension as the height of the collar boss 156, the distal surface of the collar boss 156 will be flush with the distal surface of the back plate 170. The user then rotates the hole saw 120 along with the collar 126 sixty degrees relative to the arbor 124 and retaining nut 128, the locking detents 176 on the back plate 170 of the hole saw 120 engage with the locking protrusions 182 on the proximal surface of the retaining nut 128. Additionally, as the user rotates the hole saw 120 along with the collar 126 relative to the arbor 124 and the retaining nut 128, the steel balls 154 will roll on the distal surface of the arbor platform 132. When the hole saw 120 and collar 126 have been rotated sixty degrees, the steel balls 154 will rest in the recesses 150 on the distal surface of the arbor platform 132. The hole saw 120 is then locked into place. The springs 152 force the distal surface of the collar platform 127 against the proximal surface of the back plate 170 of the hole saw 120 to provide a tight fit of the hole saw 120 on the adaptor 122.

To dismount the hole saw 120 from the adaptor 122, the user grasps the skirt 172 with one hand and the arbor 124 with the other hand. The user then pulls the hole saw 120 proximally and compresses the springs 152 to disengage the locking detents 176 and locking protrusions 182 and rotates the hole saw 120 along with the collar 126 sixty degrees relative to the retaining nut 128 and the arbor 124. Upon rotating the hole saw 120 and the collar 126 sixty degrees, the retaining nut 128 and the aperture 174 in the back plate 170 of the hole saw 120 will be in alignment. As the hole saw 120 and collar 126 are rotated, the steel balls 154 will roll out of the recesses 150 and on the distal surface of the arbor platform 132. Finally, the hole saw 120 is passed over the retaining nut 128 and the hole saw 120 is disassembled from the adaptor 122.

This second embodiment operates in a manner similar to the first embodiment. However, the second embodiment provides three contact surfaces upon which the driving force can be applied during rotation of the arbor 124.

The third embodiment of the adaptor 222 is shown in FIGS. 7 and 8. A hole saw 220 is mounted on the distal end of the adaptor 222.

An exploded view of the adaptor 222 from a distal vantage point is shown in FIG. 8. The adaptor 222 includes an arbor 224, a locking ring 286, a collar 226 and a retaining nut 228.

The arbor 224 which is preferably formed of metal includes a proximal sleeve 230, a platform 232, an arbor boss 234 and a distal sleeve 236 which are integrally formed. An arbor passageway 238 extends axially through the center of the proximal sleeve 230, the arbor platform 232, the arbor boss 234 and the distal sleeve 236.

The arbor platform 232 is generally cylindrically shaped and is distal of the proximal sleeve 230. The arbor platform 232 includes a proximal portion 232a and a distal portion 232b. A threaded bore 240 extends from the perimeter of the platform 232 to the arbor passageway 238. Threads 235 are provided on the exterior of the distal portion 232b of the arbor platform 232 and the distal portion 232b has a diameter which is slightly smaller than the proximal portion 232a.

The proximal sleeve 230 is generally cylindrically shaped with a diameter smaller than that of the arbor platform 232. A groove 231 is provided near the proximal end of the proximal sleeve 230 for coupling drive means (not shown) to the proximal sleeve 230.

The arbor boss 234 protrudes from the distal surface of the distal portion 232b of the arbor platform 232. Identical to the arbor boss 134 described with the second embodiment of the adaptor 222, the arbor boss 234 has three lobes 244 equally spaced circumferentially around the arbor passageway 238 in the “daisy” or “tri-lobular” configuration. Thus the center of each lobe 244 is spaced one hundred twenty degrees (120°) from the remaining two lobes. The radius of the arbor boss 234 at the center of each lobe 244 is smaller than the radius of the distal portion 232b of the arbor platform 232.

The distal sleeve 236 is elongated and is shaped in the “Double D” configuration with two flat sides and two rounded sides. The distal sleeve 236 extends from the distal surface of the arbor boss 234. The diameter of the distal sleeve 236 is smaller than the diameter of the distal portion 232b of the arbor platform 232.

The locking ring 286 which is preferably formed of metal or plastic is mounted on the distal portion 232b of the arbor 224. The locking ring 286 is tubular. Threads 288 are formed on the inner surface of the locking ring 286. The diameter of the locking ring 286 is such that the threads 288 engage with the threads 235 on the threaded portion 232b of the arbor 224.

The collar 226 which is preferably formed of metal, includes a collar platform 227 and a collar boss 256. The collar platform 227 and the collar boss 256 are integrally formed. A collar passageway 258 extends axially through the center of the collar platform 227 and the collar boss 256. The diameter of the collar passageway 258 is slightly larger than the diameter of the distal sleeve 236 of the arbor 224 thus, allowing the distal sleeve 236 to pass through and collar passageway 258.

A collar boss 256 protrudes from the distal surface of the collar platform 227. The collar boss 256 has three lobes 260 equally spaced circumferentially around the collar passageway 258 in the “daisy” or “tri-lobular” configuration. A collar recess 278 (identical to the collar recess 178 shown in FIG. 6) extends into the proximal surface of the collar platform 227. The relative dimensions of the arbor boss 234 and the collar recess 278 are such that the arbor boss 234 fits within the collar recess 278 and can be rotated approximately sixty degrees (60°) relative to the collar recess 278.

The retaining nut 228 has three lobes 264 and is shaped in the “daisy” or “tri-lobular” configuration and has an aperture 268 located at its axial center. The aperture 268 of the retaining nut 228 is shaped in the “Double D” configuration and is slightly larger than the perimeter of the distal sleeve 236. The perimeter of the retaining nut 228 is of the same shape and dimensions as the perimeter of the collar boss 256.

The adaptor 222 is assembled by passing the locking ring 286 over the distal sleeve 236 of the arbor 224 and over the arbor boss 234. The threads 288 of the locking ring 286 are threadedly engaged with the threads 235 on the distal portion 232b of the platform 232 until the distal surface of the locking ring 286 is aligned with the distal surface of the platform 232. Next, the distal sleeve 236 is passed through the collar passageway 258. The lobes 244 of the arbor boss 234 are aligned with the lobes of the collar recess 278. The distal sleeve 236 is then passed through the aperture 268 of the retaining nut 228. The retaining nut 228 abuts the collar boss 256 and is fixed to the distal sleeve 236 using a peening process. Because the retaining nut 228 abuts the collar boss 256 and is fixed to the distal sleeve 236 of the arbor 224, the retaining nut 228 will rotate with the arbor 224. The collar 226 will rotate relative to the arbor 222 and the retaining nut 228.

The cylindrical shank of a pilot bit 242 is inserted in the arbor passageway 238 and locked in place by tightening a set screw (not shown) located in the threaded bore 240. The pilot drill bit 242 when inserted in the arbor passageway 238, extends through the collar passageway 258 and the aperture 268 in the retaining nut 228.

The hole saw 220 includes a circularly shaped back plate 270 and a cylindrically shaped skirt 272 depends therefrom. The thickness of the back plate 270 is the same dimension as the height of the collar boss 256. A “daisy shaped” aperture 274 is located at the axial center of the back plate 270.

The hole saw 220 is assembled with the adaptor 222 by passing the aperture 274 in the back plate 270 of the hole saw 220 over the pilot drill bit 242, passing the aperture 274 over the retaining nut 228 and aligning the collar boss 256 within the aperture 274. Because the thickness of the back plate 270 is the same dimension as the height of the collar boss 256, the distal surface of the collar boss 256 will be flush with the distal surface of the back plate 270. The user then rotates the hole saw 220 along with the collar 226 sixty degrees relative to the arbor 224 and the retaining nut 228 is no longer aligned with the aperture 274, and the lobes 264 of the retaining nut 228 are aligned between the lobes 275 of the aperture 274 in the back plate 270 of the hole saw 220. The hole saw 220 is then secured into place by rotating the locking ring 286 so that the locking ring moves distally, but maintains its threaded engagement with the distal portion 232b of arbor 224. As the locking ring 286 is moved distally, the collar 226 is moved away from the arbor 224 and against the back plate 270 of the hole saw 220. This provides a tight fit between the hole saw 220 and the adaptor 222.

The hole saw 220 is dismounted from the adaptor 222 by rotating the locking ring 286 so that it moves proximally thus moving the collar 226 away from the back plate 270 of the hole saw 220. The hole saw 220 can then be rotated so as to align the aperture 274 with the retaining nut 228. Finally, the hole saw 220 is passed over the retaining nut 228 to dismount the hole saw 220 from the adaptor 222.

A fourth embodiment of the adaptor 322 is shown in FIGS. 9 and 10. A hole saw 320 is mounted on the distal end of the assembled adaptor 322.

An exploded view of the adaptor from a distal vantage point is shown in FIG. 10. The adaptor 322 includes an arbor 324, a collar 326, and a retaining nut 328.

The arbor 324 which is preferably formed of metal, includes a proximal sleeve 330, an arbor platform 332, an arbor boss 334 and a distal sleeve 336. The proximal sleeve 330, the arbor platform 332, the arbor boss 334 and the distal sleeve 336 are integrally formed. An arbor passageway 338 extends axially through the center of the proximal sleeve 330, the arbor platform 332, the arbor boss 334, and the distal sleeve 336.

The arbor platform 332 is generally cylindrically shaped and is distal of the proximal sleeve 330. The proximal sleeve 330 is generally cylindrically shaped with a diameter smaller than that of the arbor platform 332. A groove 331 is provided near the proximal end of the proximal sleeve 330. A threaded bore 340 extends from the perimeter of the arbor platform 332 to the arbor passageway 338. The threaded bore 340 is perpendicular to the arbor passageway 338.

The arbor boss 334 protrudes from the distal surface of the arbor platform 332 of the arbor 324. In this fourth embodiment, the arbor boss 334 is generally triangularly shaped with three rounded corners 344. Each corner 344 is spaced one hundred twenty degrees from the remaining two corners.

The distal sleeve 336 is elongated and generally triangularly shaped with three rounded corners and extends from the distal surface of the arbor boss 334. The diameter of the distal sleeve 336 is smaller than the diameter of the arbor platform 332.

Three recesses 350 (two of which are shown) are provided in the distal surface of the arbor platform 332 and receive steel balls 354. The recesses 350 are spaced between the rounded corners 344 of the arbor boss 334. The steel balls 354 are placed within the recesses 350 and springs 352 rest on the balls 354. As will be described herein, the springs 352 provide tension and the steel balls roll on the distal surface of the arbor platform 332 when the hole saw 320 is mounted with or dismounted from the adaptor 322.

The collar 326 which is preferably formed of metal includes a collar platform 327 and a collar boss 356 which are integrally formed. A collar passageway 358 extends axially through the center of the collar platform 327 and the collar boss 356. The diameter of the collar passageway 358 is slightly larger than the diameter of the distal sleeve 336 of the arbor 324 thus allowing the distal sleeve 336 to pass through the collar passageway 358.

A collar boss 356 protrudes from the distal surface of the collar platform 327. The collar boss 356 is generally triangularly shaped with three rounded corners 360 equally spaced circumferentially around the collar passageway 358.

A collar recess 378 extends from the proximal surface of the collar platform 327. The relative dimensions of the arbor boss 334 and the collar recess 378 are such that the arbor boss 334 fits within the collar recess 378 and can be rotated within the collar recess approximately 60 degrees.

Bores 367 are located in the proximal surface of the collar platform 327. The bores 367 receive the springs 352. The height of the collar 326 from the proximal surface of the collar platform 327 to the distal surface of the collar boss 356 relative to the length of the distal sleeve 336 is such that when the arbor boss 334 is positioned within the collar recess 378, the distal sleeve 336 extends beyond the distal surface of the collar boss 356.

The retaining nut 328 is also generally triangularly shaped with three rounded corners 364 and an aperture 368 located at its axial center. The aperture 368 is generally triangularly shaped with rounded corners. The perimeter of the retaining nut 328 is of the same shape and dimensions as the perimeter of the collar boss 356. Three locking protrusions (not shown) are provided on the proximal surface of the retaining nut 328. The locking protrusions are spaced outwardly from the aperture 368 at each of the rounded corners 364.

To assemble the adaptor 322, the collar 326 is passed over the distal sleeve 336 of the arbor 324. The collar 326 is rotated so as to align the arbor boss 334 within the collar recess 378. Next, the distal sleeve 336 of the arbor 324 is passed through the aperture 368 of the retaining nut 328. The locking protrusions of the retaining nut 328 abut the collar boss 356 and the retaining nut 328 is fixed to the distal sleeve 336 of the arbor 324. Thus, the retaining nut 328 will rotate with the arbor 324 and the collar 326 will rotate relative to the arbor 322 and the retaining nut 328.

The cylindrical shank of a pilot drill bit 342 is inserted in the arbor passageway 338 and locked in place by tightening a set screw (not shown) located in the threaded bore 340. The pilot drill bit 342 when inserted in the arbor passageway 338, extends through the collar passageway 358 and the aperture 368 in the retaining nut 328.

The hole saw 320 includes a circularly shaped back plate 370 and a cylindrically shaped skirt 372 which depends from the back plate 370. The thickness of the back plate 370 is the same dimension as the height of the collar boss 356. A generally triangularly shaped aperture 374 is provided through the axial center of the back plate 370. The aperture 374 is slightly larger than the perimeter of the retaining nut 328 and the collar boss 356 thus allowing the retaining nut 328 and the collar boss 356 to pass through the aperture 374. Three inwardly protruding locking detents 376 (two of which are shown) are located on the distal surface of the back plate 370. The locking detents 376 are spaced between the rounded corners of the aperture 374.

The hole saw 320 is mounted to the adaptor 322 by the user by passing the aperture 374 in the hole saw 320 over the pilot drill bit 342, aligning the retaining nut 328 with the aperture 374 in the back plate 370 of the hole saw 320, passing the hole saw 320 over the retaining nut 328 such that the aperture 374 passes over the retaining nut 328, and aligning the collar boss 356 within the aperture 374. The proximal side of the back plate 370 will abut the distal side of the collar platform 327. Because the thickness of the back plate 370 is the same dimension as the height of the collar boss 356, the distal surface of the collar boss 356 will be flush with the distal surface of the back plate 370. The user then rotates the hole saw 320 and the collar 326 sixty degrees relative to the arbor 324 and the retaining nut 328, and the locking detents 376 on the back plate 370 of the hole saw 320 engage with the locking protrusions on the retaining nut 328 to lock the hole saw into place. As the hole saw 320 and the collar 326 are rotated, the steel balls 354 roll on the distal surface of the arbor platform 332. When the locking detents 376 are aligned with the locking protrusions, the steel balls 354 will rest in the recesses 350. The springs 352 force the distal surface of the collar 326 against the proximal surface of the back plate 370 of the hole saw 320 to provide a tight fit of the hole saw 320 on the adaptor 322.

The configuration of this fourth embodiment also provides three surfaces of contact between the arbor boss 334 and the collar recess 378 and the collar boss 356 and the aperture 374 in the backplate 370.

A fifth embodiment of the adaptor 422 is shown in exploded form from a distal vantage point in FIG. 11. The adaptor 422 includes an arbor 424, an O-ring 425, a collar 426 and a retaining nut 428.

The arbor 424 includes a proximal sleeve 430, a platform 432, an arbor boss 434 and a distal sleeve 436 which are integrally formed. An arbor passageway (not shown) extends through the axial center of the proximal sleeve 430, the platform 432, the arbor boss 434 and the distal sleeve 436.

The arbor platform 432 is generally cylindrically shaped and is distal of the proximal sleeve 430. The proximal sleeve 430 is generally cylindrically shaped with a diameter smaller than that of the arbor platform 432. The proximal sleeve 430 has six flat sides for coupling with conventional drive means (not shown). A threaded bore (not shown) extends from the perimeter of the platform 432 to the arbor passageway 438. A groove 490 is located on the platform 432 of the arbor 424. An O-ring 425 fits within the groove 490 for reasons described herein.

The arbor boss 434 protrudes from the distal surface of the arbor platform 432. In this fifth embodiment, the arbor boss 434 includes three curved inclined wedges 444 which are equally spaced around the axial center of the platform 432.

The distal sleeve 436 is elongated and shaped in the “Double D” configuration with two flat sides and two rounded ends. The distal sleeve 436 extends from the distal surface of the arbor boss 434. The diameter of the distal sleeve 436 is smaller than the diameter of the arbor platform 432.

The collar 426 which is preferably made of metal, includes a collar platform 427 and a collar boss 456 which are integrally formed. The collar platform 427 includes a generally circular collar wall 429 and collar skirt 431 which depends from the collar wall 429. The inner diameter of the collar skirt 431 is slightly larger than the outer diameter of the arbor platform 432. A collar passageway 458 extends axially through the center of the collar platform 427 and the collar boss 456. The diameter of the collar passageway is slightly larger than the diameter of the distal sleeve 436 of the arbor 424 thus allowing the distal sleeve 436 to pass through the collar passageway 458.

The collar boss 456 protrudes from the distal surface of the collar platform 427. The collar boss 456 is shaped in the “daisy” or “tri-lobular” configuration and has three equally spaced lobes 460. The diameter of the collar boss 456 is smaller than the diameter of the collar platform 427.

As shown in FIG. 12, the collar recess 478 includes three inclined wedges 480 (two of which are shown) which correspond to the inclined wedges 444 of the arbor boss 434. The wedges 480 extend from the collar wall 429 and abut the collar skirt 431.

The retaining nut 428 is also “daisy” shaped and has three equally spaced lobes 464 (two of which are shown). The perimeter of the retaining nut 428 is of the same shape and dimension as the perimeter of the collar boss 456. The retaining nut 428 has an aperture 468 located at its axial center. The aperture 468 is shaped in the “double D” configuration.

To assemble the adaptor 422, the collar 426 is passed over the distal sleeve 436 of the arbor 424. The collar 426 is rotated so as to align the arbor boss 434 within the collar recess 478. Because the inner diameter of the collar skirt 431 is larger than the outer diameter of the arbor platform 432, the collar skirt 431 will partially surround the arbor platform 432 and the O-ring 425 will contact the inner surface of the collar skirt 431. As the collar 426 is assembled with the arbor 424, the inclined wedges 444 of the arbor boss 434 will contact the corresponding inclined wedges 480 of the collar recess 478. Next, the distal sleeve 436 of the arbor 424 is passed through the aperture 468 of the retaining nut 428. The retaining nut 428 abuts the collar boss 456 and is fixed to the distal sleeve 436 using a peening process. Because the retaining nut 428 is fixed to the distal sleeve 436 of the arbor 424, the retaining nut 428 will rotate with the arbor 424. The collar 426 will rotate relative to the arbor 422 and the retaining nut 428.

The cylindrical shank of the pilot bit 442 is inserted in the arbor passageway and locked in place by tightening a set screw (not shown) located in the threaded bore (not shown). The pilot drill bit 442 when inserted in the arbor passageway, extends through the collar passageway 458 and the aperture 468 in the retaining nut 428.

The hole saw 420 includes a circularly shaped back plate 470 and a cylindrically shaped skirt 472 which depends from the back plate 470. The thickness of the back plate 470 is the same dimension as the height of the collar boss 456. An aperture 474 is located at the axial center of the back plate 470. The aperture 474 is shaped in the “daisy” configuration with three lobes 475 (two of which are shown).

The hole saw 420 is mounted to the adaptor by the user by passing the aperture 474 in the hole saw 420 over the pilot drill bit 442, aligning the retaining nut 428 with the aperture 474 in the back plate 470 of the hole saw 420, passing the hole saw 420 over the retaining nut 428 such that the aperture 474 passes over the retaining nut 428, and aligning the collar boss 456 within the aperture 474. The proximal side of the back plate 470 will abut the distal side of the collar platform 427. Because the thickness of the back plate 470 is the same dimension as the height of the collar boss 456, the distal surface of the collar boss 456 will be flush with the distal surface of the back plate 470. The user then rotates the hole saw 420 and the collar 426 approximately sixty degrees relative to the arbor 424 and the retaining nut 428, so that the retaining nut 428 is no longer aligned with the aperture 474 in the back plate 470 of the hole saw 420. As the user rotates the hole saw 420 and collar 426 relative to the retaining nut 428 and arbor 424, the inclined wedges 444 of the arbor boss 434 push against the corresponding inclined wedges 480 of the collar recess 478. Thus, the collar 426 is moved away from the arbor 424 and the distal surface of the collar platform 427 is moved against the proximal surface of the back plate 470 of the hole saw 420. The arbor 424 will continue to rotate relative to the collar 426 until the distal surface of the collar 426 fits securely against the proximal surface of the saw 420 thus securing the hole saw 420 in place. The O-ring 425 provides friction between the arbor 424 and the collar 426 to prevent accidental removal of the hole saw 420 from the adaptor 422.

When power is supplied, drive means which are attached to the six sided proximal sleeve 430 will cause the arbor 424 to rotate. The engagement of the inclined wedges 444 with the inclined wedges 480 will cause the collar to rotate. The collar boss 456 engages with the aperture 474 in the hole saw 420 causing the hole saw 420 to rotate. As the hole saw 420 rotates, the cutting edge 484 of the hole saw 420 cuts the surface of the work piece (not shown).

To dismount the hole saw 420, the collar 426 is rotated relative to the arbor 424 in a direction opposite to that provided by the drive means. In order to rotate the collar 426 relative to the arbor 424, the friction provided by the O-ring 425 must be overcome. As the collar 426 is rotated the inclined wedges 480 will come out of contact with the inclined wedges 444 and the distal surface of the collar 426 will no longer be in contact with the proximal surface of the hole saw 420. The hole saw 420 can then be rotated relative to the retaining nut 428 until the retaining nut 428 is aligned with the aperture 474 in the back plate 470 of the hole saw 420. Finally, the hole saw can be passed over the retaining nut 428 and dismounted from the adaptor 422.

In FIG. 13, there is shown an alternative embodiment of a retaining nut 528. The retaining nut 528 is generally triangularly shaped with three rounded corners. A passageway 568 is provided at the axial center of the retaining nut 528 and includes a retaining nut boss 563 which protrudes from the distal side of side of the retaining nut 528. Rather than using a peening process to fix the retaining nut to the distal sleeve as described in the previous embodiments, the retaining nut boss 563 is mushroomed to fix the retaining nut 528 to the distal sleeve of the arbor.

It is to be understood that the retaining nut boss described in reference to FIG. 13 could be used in connection with any of the embodiments described above. Additionally, although the locking protrusions and locking detents aid in the mounting of the hole saw to the adaptor, the locking protrusions and locking detents are not essential to the function of the invention.

It is also to be understood that the configuration of the arbor boss does not need to be the same as the configuration of the collar boss. For example, the collar A boss could be of the triangular configuration with rounded corners while the arbor boss and the collar recess include inclined wedges. The arbor boss must, however, be shaped in a manner which allows it to mate with the collar recess. Likewise the collar boss, retaining nut and aperture in the back plate of the hole saw must be similarly shaped.

The tensioning elements of springs and steel balls placed between the arbor and the collar were described in connection with the first, second and fourth embodiments of the invention. A locking ring has been described as the tensioning means used in the third embodiment of the invention. It is to be understood that any of the various tensioning means can be used with the various embodiments of the invention. In the case of the springs and steel balls located between the collar and the arbor, the position of the steel balls and springs can be reversed. In that case, bores would be placed in the distal side of the arbor to receive the springs and the steel balls would rest in detents and roll on the proximal side of the collar. Additionally, although the embodiments described above include two or three spring and steel ball combinations, the same function can be essentially achieved by using only one spring and ball combination. It is also to be understood that operation of the adaptor is improved with the use of tensioning means, however, the adaptor will operate without tensioning means.

The proximal sleeve of the adaptor has been shown as rounded and with six flat sides. The proximal sleeve could also be three sided or any other shape which allows connection to the drive means to be used. The groove on the proximal sleeve of the adaptor is not required for the adaptor to function, however, the groove aids in connecting the drive means.

While preferred embodiments of the present invention are shown and described, it is envisioned that those skilled in the art may devise various modifications of the present invention without departing from the spirit and scope of the appended claims.

The invention claimed is:

1. An adaptor for use with a hole saw, said adaptor comprising:
an arbor having a sleeve extending therefrom;
a collar having a passageway extending therethrough;
a retaining nut;
said sleeve positioned through said collar passageway;
said retaining nut non-rotatably attached to said sleeve;
said collar being capable of rotating relative to said arbor and said retaining nut; and
means for limiting the rotation of said collar relative to said arbor and said retaining nut.

2. An adaptor as defined in claim 1, wherein said collar further comprises a collar platform and a recess within said collar platform;
wherein said arbor further comprises an arbor boss, said arbor boss being positioned within said collar recess and forming said means for limiting the rotation of said collar relative to said arbor and said retaining nut.

3. An adaptor as defined in claim 2, wherein said arbor boss includes two diametrically opposed lobes, said recess includes two diametrically opposed lobes, and said arbor boss is capable or rotating 90 degrees within said recess.

4. An adaptor as defined in claim 2, wherein said arbor boss is tri-lobular, said recess is tri-lobular and said arbor boss is capable of rotating 60 degrees within said recess.

5. An adaptor as defined in claim 2, wherein said arbor boss includes an inclined arbor wedge and said recess includes an inclined collar wedge which corresponds to said inclined arbor wedge.

6. An adaptor as defined in claim 5, wherein said inclined arbor wedge is curved and said inclined collar wedge is curved.

7. An adaptor as defined in claim 1, further comprising means for moving said collar away from said arbor.

8. An adaptor as defined in claim 7, wherein said moving means includes a spring positioned between said arbor and said collar.

9. An adaptor as defined in claim 8, further including a ball positioned between said spring and said arbor.

10. An adaptor as defined in claim 9, further including a recess on said arbor for receiving said ball.

11. An adaptor as defined in claim 8, further including a bore within said collar for receiving a portion of said spring.

12. An adaptor as defined in claim 8, further including a ball positioned between said spring and said collar.

13. An adaptor as defined in claim 12, further including a recess on said collar for receiving said ball.

14. An adaptor as defined in claim 9, further including a bore within said arbor for receiving a portion said spring.

15. An adaptor as defined in claim 7, wherein said moving means comprises threads on the perimeter of said arbor and a locking ring threadedly engaged with said threads, said locking ring capable of moving said collar away from said arbor.

16. An adaptor as defined in claim 1, wherein said arbor further comprises a groove on the perimeter of said arbor and an O-ring positioned within said groove.

17. An adaptor as defined in claim 1, wherein said collar includes a collar platform, and a collar boss extending from said collar platform.

18. An adaptor as defined in claim 17, wherein said collar boss includes two diametrically opposed lobes and wherein said retaining nut includes two diametrically opposed lobes.

19. An adaptor as defined in claim 18, wherein the rotation of said collar relative to said arbor and said retaining nut is limited to 90 degrees.

20. An adaptor as defined in claim 17, wherein said collar boss is tri-lobular and wherein said retaining nut is tri-lobular.

21. An adaptor as defined in claim 20, wherein the rotation of said collar relative arbor and said retaining nut is limited to 60 degrees.

22. An adaptor as defined in claim 17, wherein said collar boss is triangular and wherein said retaining nut is triangular.

23. An adaptor as defined in claim 17, wherein the rotation of said collar relative to said arbor and said retaining nut is limited to 60 degrees.

24. An adaptor as defined in claim 1, wherein said arbor further includes an arbor passageway and a threaded bore extending from a perimeter of said arbor to said arbor passageway for receiving a set screw for retaining a pilot drill bit within said arbor passageway.

25. An adaptor as defined in claim 1, wherein said retaining nut further includes locking protrusions on a proximal surface of said retaining nut.

26. An adaptor as defined in claim 1, wherein said retaining nut further includes locking detents on a proximal surface of said retaining nut.

27. An adaptor as defined in claim 1, further including a retaining nut boss extending from said retaining nut, wherein said retaining nut boss is mushroomed so as to attach said retaining nut to said sleeve.

28. An adaptor as defined in claim 1, wherein said retaining nut is attached to said sleeve by peening.

29. An adaptor for use with a hole saw, said adaptor comprising:
a collar, comprising a collar platform, a recess within said collar platform, a collar boss extending from said collar platform, and a passageway extending through said collar;
an arbor, comprising an arbor boss and having a sleeve extending therefrom;
said sleeve positioned within said passageway;
a retaining nut;
said retaining nut non-rotatably attached to said sleeve;
said collar being capable of rotating relative to said arbor and said retaining nut; and
wherein said arbor boss is positioned within said recess and limits the rotation of said collar relative to said arbor and said retaining nut.

30. An adaptor as defined in claim 29, wherein said collar boss includes two diametrically opposed lobes and wherein said retaining nut includes two diametrically opposed lobes.

31. An adaptor as defined in claim 30, wherein the rotation of said collar relative to said arbor and said retaining nut is limited to 90 degrees.

32. An adaptor as defined in claim 29, wherein said collar boss is tri-lobular and wherein said retaining nut is tri-lobular.

33. An adaptor as defined in claim 32, wherein the rotation of said collar relative to said arbor and said retaining nut is limited to 60 degrees.

34. An adaptor as defined in claim 29, wherein said collar boss is triangular and wherein said retaining nut is triangular.

35. An adaptor as defined in claim 34, wherein the rotation of said collar relative to said arbor and said retaining nut is limited to 60 degrees.

36. An adaptor as defined in claim 29, wherein said recess includes an inclined collar wedge and wherein said arbor boss includes an inclined arbor wedge which corresponds to said inclined collar wedge.

37. An adaptor as defined in claim 36, wherein said inclined collar wedge is curved and said inclined arbor wedge is curved.

38. In combination, a hole saw and an adaptor comprising:
a hole saw comprising:
a backplate,
an skirt depending from said backplate,
a cutting edge located on the free end of said skirt,
an aperture through said backplate; and
an adaptor comprising:
an arbor having a sleeve extending therefrom,
a collar having a passageway extending therethrough,
a retaining nut,
said sleeve positioned through said collar passageway,
said retaining nut non-rotatably attached to said sleeve,
said collar being capable of rotating relative to said arbor and said retaining nut, and
means for limiting the rotation of said collar relative to said arbor and said retaining nut.

39. The combination as defined in claim 38, wherein said collar includes a collar platform and a collar boss extending from said collar platform.

40. The combination as defined in claim 38, wherein said aperture of said hole saw includes two diametrically opposed lobes and said collar boss of said adaptor includes two diametrically opposed lobes and wherein said collar boss fits within said aperture.

41. The combination as defined in claim 38, wherein said aperture of said hole saw is tri-lobularly shaped and said collar boss of said adaptor is tri-lobularly shaped and wherein said collar boss fits within said aperture.

42. The combination as defined in claim 38, wherein said aperture of said hole saw is triangularly shaped and said collar boss of said adaptor is triangularly shaped and wherein said collar boss fits within said aperture.

43. The combination as defined in claim 38, wherein a thickness of said backplate of said hole saw is no larger than a thickness of said collar boss of said adaptor.

44. The combination as defined in claim 38, further including locking detents on a distal surface of said back plate of said hole saw.

45. The combination as defined in claim 38, further including locking protrusions on a distal surface of said back plate of said hole saw.

46. The combination as defined in claim 38, wherein said collar includes a collar platform and an inclined collar wedge extending from said collar platform, wherein said arbor includes an arbor platform and an inclined arbor wedge extending from said arbor platform, and said inclined collar wedge corresponds to said inclined arbor wedge.

47. The combination as defined in claim 46, wherein said inclined collar wedge is curved and said inclined arbor wedge is curved.

48. A method of mounting a hole saw to an adaptor comprising the steps of:
providing a hole saw including a back plate, a skirt depending from said back plate, and an aperture through said backplate;
providing an adaptor including an arbor having a sleeve extending therefrom, a collar having a passageway extending therethrough, a retaining nut, said sleeve positioned through said collar passageway, said retaining nut being non-rotatably attached to said sleeve, said collar being capable of rotating relative to said arbor and said retaining nut, and means for limiting the rotation of said collar relative to said arbor and said retaining nut;
passing the retaining nut through said aperture in said back plate of said hole saw;
placing said collar within said aperture in said hole saw; and
rotating said collar and said hole saw relative to said arbor and said retaining nut.

49. The method of claim 48 wherein said adaptor includes means for moving said collar away from said arbor, and further including the step of activating said means to move said collar away from said arbor after said step of rotating said collar and said hole saw relative to said arbor and said retaining nut.

50. The method of claim 48, wherein said adaptor further includes a spring positioned between said arbor and said collar and a ball positioned between said arbor and said spring, further including the step of compressing said spring before rotating the collar and hole saw, thereby rolling the ball on a surface of the arbor as said collar and said hole saw are rotated, and releasing said compression on the spring.

51. The method of claim 48, wherein said adaptor further includes a locking ring threadedly engaged with said arbor, further including the step of rotating said locking ring so as to at least partially disengage said locking ring from said arbor and move said collar distally after rotating said collar and said hole saw.

52. The method of claim 48, wherein said adaptor further includes an O-ring positioned in a groove around a perimeter of said arbor, further including the step of overcoming a frictional force provided between said O-ring and said collar when rotating said collar and said hole saw.

53. The method of claim 48, further including the step of positioning a pilot drill bit within said collar passageway.

54. The method of claim 48, wherein the arbor of said provided adaptor further includes a platform and an inclined arbor wedge extending from said platform, wherein the collar of said provided adaptor further includes a platform and an inclined collar wedge extending from said platform, and wherein said inclined arbor wedge corresponds to said inclined collar wedge.

55. An adaptor for use with a hole saw, said adaptor comprising:
an arbor including, an arbor platform, a sleeve extending from said arbor platform, and an inclined arbor wedge extending from said arbor platform;
a collar including, a passageway extending therethrough, a collar platform, a collar boss extending from said collar platform, and an inclined collar wedge extending from said collar platform;
a retaining nut;
said sleeve positioned through said collar passageway;
said retaining nut non-rotatably attached to said sleeve;
said collar being capable of rotating relative to said arbor and said retaining nut;
wherein said arbor wedge corresponds to said collar wedge; and
wherein said arbor wedge contacts said collar wedge thereby limiting the rotation of said collar relative to said arbor and said retaining nut.

56. An adaptor as defined in claim 55, wherein said inclined arbor wedge is curved and said inclined collar wedge is curved.

57. An adaptor as defined in claim 55, wherein said arbor further includes a groove on the perimeter of said arbor platform and O-ring positioned within said groove.

58. An adaptor as defined in claim 55, wherein said collar boss is tri-lobular and wherein said retaining nut is tri-lobular.

59. An adaptor as defined in claim 55, further including a retaining nut boss extending from said retaining nut, wherein said retaining nut boss is mushroomed so as to attach said retaining nut to said sleeve.
